(19) United States
(12) Patent Application Publication
(10) Pub. No.: US 2016/0305913 A1
(43) Pub. Date: Oct. 20, 2016

(54) DEVICE AND ASSEMBLY FOR NON-DESTRUCTIVE TESTING OF A COMPOSITE PART AND METHOD FOR NON-DESTRUCTIVE TESTING OF A COMPOSITE PART THROUGH TRANSMISSION ULTRASOUND

(71) Applicant: AIRCELLE, Gonfreville L'Orcher (FR)

(72) Inventor: Andre BAILLARD, BRETTEVILLE DU GRAND CAUX (FR)

(73) Assignee: AIRCELLE, GONFREVILLE L'ORCHER (FR)

(21) Appl. No.: 15/193,157

(22) Filed: Jun. 27, 2016

Related U.S. Application Data
(63) Continuation of application No. PCT/FR2014/053436, filed on Dec. 18, 2014.

(30) Foreign Application Priority Data
Jan. 2, 2014 (FR) 14/50013

(51) Int. Cl. G01N 29/22

(52) U.S. Cl. CPC G01N 29/223

(57) ABSTRACT

The disclosure relates to a device for non-destructive testing of a composite part that includes at least two magnetic bodies, at least one of said at least two magnetic bodies being adapted such as to exercise a force of attraction such as to allow mutual restraint, or restraint of one by the other, of the magnetic bodies on either side of said part, said magnetic bodies being intended to be positioned directly on at least one wall of the part to be tested; and at least one transmitting ultrasound probe positioned on one of said magnetic bodies, and at least one receiving ultrasound probe positioned on the other one of said magnetic bodies.

### CROSS-REFERENCE TO RELATED APPLICATIONS

This application is a continuation of International Application No. PCT/FR2014/053436, filed on Dec. 18, 2014, which claims the benefit of FR 14/50013 filed on Jan. 2, 2014. The disclosures of the above applications are incorporated herein by reference.

### FIELD

The present disclosure is related to the field of non-destructive testing of parts made of composite materials, and more specifically to devices for the non-destructive testing (NDT) of a composite parts and assemblies.

### BACKGROUND

The statements in this section merely provide background information related to the present disclosure and may not constitute prior art.

A method for manufacturing or repairing a part made of composite material generally comprises a step of testing if said part complies with previously defined specifications. It should be typically verified that the manufactured or repaired part has no defect, in particular a bonding or delamination defect.

Known testing methods are usually carried out by means of a non-destructive testing device.

Among the non-destructive testing methods, the method of testing through emission of transmission ultrasounds is known from the state of the art, consisting of sending ultrasonic waves into the manufactured or repaired part, then analyzing the signal when the waves have crossed said part.

Such a method may be implemented by a transmission ultrasonic testing device, conventionally comprising an emitting ultrasonic transducer and a receiving ultrasonic transducer.

The testing of the part can be carried out either manually by an operator, which moves the emitting and receiving transducers on the surface of the test part, or automatically by means of robotic arms connecting each transducer in order to scan the surface of the part.

Such an automated device is advantageous with respect to manual testing in that it provides a relative constant positioning between the transducers.

However, the presence of arms supporting and moving the transducers limits access to some areas of the test part when the test part has a curved profile. Furthermore, the manufacture of the automated arms is expensive.

The European patent application published under the number EP 1 500 929 is known from the prior art, which attempts to overcome these drawbacks by providing an ultrasonic testing device with a magnetic coupling between the emitting and receiving probes.

FIG. 1 illustrates a probe 1 of the prior art. The probe 1 comprises a casing 3 enclosing an emitting or receiving ultrasonic transducer 5, positioned next to magnets 7, 9.

The probes are disposed on either side of the test part, so that the conductive probe, connected for example to a robotic arm, drives the displacement of the tracking probe thanks to the presence of the magnets.

This makes it possible to get away from the presence of a second robotic arm connected to the tracking probe, which allows reducing the manufacturing costs of the testing device.

However, in order to enable a correct positioning of the probes therebetween, each probe requires several disposed magnetic bodies around the transducer, which results in probes particularly cumbersome and not well adapted to the testing of the curved-profile parts.

In addition, when the test part is a repaired part, it is common that the test part comprises other inserts, which cannot be removed from the testing time, thus limiting the accessibility of the probes to the test part.

The US Patent Application 2006/0053892 is also known from the prior art, which also describes an ultrasonic testing device whose emitting and receiving probes are magnetically coupled so as to have a conductive probe and a tracking probe.

As shown in FIG. 2, the magnetic coupling is here achieved by means of a single magnetic toroidal body 11 by probe 1, the transducer 5 being positioned inside the magnetic toroidal body.

In order to limit the impact that the toroidal shape of the magnetic body generates on the developed magnetic power, it is necessary to provide for a torus having a significant diameter in order to provide a magnetic power sufficient to attract the magnet located on the other side of the test part.

Thus, in this device of the prior art, the contact surface between one of the probes and the test part has a diameter at least equal to that of the torus of the magnetized body. The testing device is particularly cumbersome, and therefore not very adapted to the testing of curved parts.

### SUMMARY

The present disclosure aims to solve the drawbacks of the prior art and of the abovementioned inventions, and relates for this purpose to a device for the non-destructive testing of a test composite part, remarkable in that it comprises:
at least two magnetic bodies, at least one of said at least two magnetic bodies being adapted to exert an attractive force to allow a mutual holding, or a holding through the one by the other, of the magnetic bodies on either side of said part, said magnetic bodies being intended to be positioned directly on at least one wall of the test part, and
at least one emitting ultrasonic probe positioned on the one of said magnetic bodies, and at least one receiving ultrasonic probe positioned on the other of said magnetic bodies.

Thus, by providing for disposing the magnetic bodies directly on the walls of the test part, on either side of the test part, and by providing for an emitting probe and a receiving probe each positioned about a magnetic body, only the magnetic bodies are in contact with the walls of the test part. Thus, the contact surface between the testing device and the test part is considerably reduced compared to the prior art, which allows to limit the congestion of the testing device at the contact surface of the test part, and consequently, to significantly improve, compared to the prior art, the accessibility to some areas of the test part.

According to all optional features of the device according to the present disclosure:
at least one of said magnetic bodies comprises a holding ring shaped to support at least one of said probes;
at least one magnetic body has a substantially cylindrical shape, which allows to ensure a distribution of the magnetic field along the longitudinal axis of the magnetic body, and thus to simultaneously move the probes;
at least one magnetic body is made of magnetically hard material such as an alloy of neodymium, iron and boron, this alloy providing good magnetic properties;
the emitting ultrasonic probe further comprises at least one emitting ultrasonic transducer and the receiving ultrasonic probe comprises further at least one receiving ultrasonic transducer.

The present disclosure also concerns an assembly comprising a composite test part and at least one device for the non-destructive testing of said part, said device comprising at least two-magnetic bodies and at least one emitting ultrasonic probe and at least one receiving ultrasonic probe, said assembly being remarkable in that the magnetic bodies are positioned on either side of the test part, directly on a wall of said part, at least one of said at least two magnetic bodies exerting an attractive force adapted to allow a mutual holding, or a holding through the one by the other, of the magnetic bodies on either side of said part, and in that said emitting and receiving ultrasonic probes are positioned respectively on either one of said magnetic bodies.

Futher, the disclosure relates to a method for non-destructive testing of a test composite part through transmission ultrasounds, remarkable in that it further comprises the following steps:
positioning on either side of the test part at least two magnetic bodies, so that at least one of said at least two magnetic bodies exerts an attractive force to allow a mutual holding, or a holding through the one by the other, of the magnetic bodies on either side of said part, said magnetic bodies being positioned directly on a wall of the test part,
positioning at least one emitting ultrasonic probe on the one of the magnetic bodies, and at least one receiving ultrasonic probe on the other of the magnetic bodies.

The method according to the disclosure further comprises a step for wetting the test part, for example by vaporization.

In addition, optionally, said at least two magnetic bodies are positioned substantially facing each other.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1 and 2 illustrate exemplary embodiments of probes for a device for the non-destructive testing of a composite part according to the prior art;

FIG. 3 represents a device for the non-destructive testing of a composite part according to the present disclosure, mounted on a composite part to be tested.

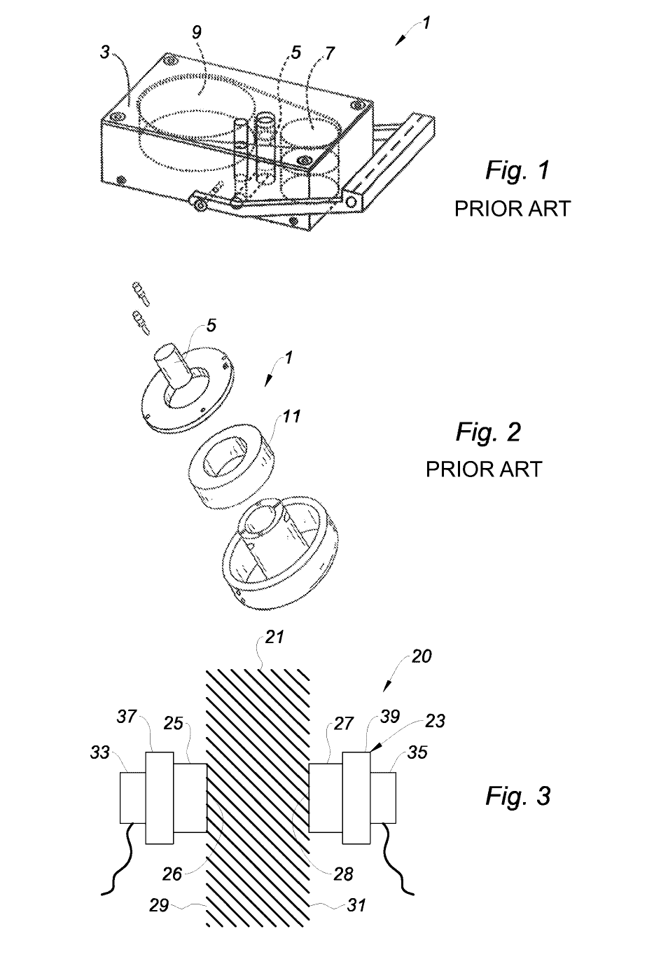

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

On all the figures, identical or similar references designate identical or similar members or sets of members.

Reference is made to FIG. 3, illustrating an assembly 20 comprising a test composite part 21 to be tested and a device 23 according to the present disclosure for the non-destructive testing of the composite part 21.

The test composite part 21 can be, by way of an illustrative and non-limiting example, a composite structure called “sandwich” structure, comprising a first skin called an “inner skin” and a second skin called an “outer skin” separated by a honeycomb structure, which in one form may be “NIDA.”

This type of composite structure finds application in particular in the field of aeronautics, and equips commonly some sections of the nacelles for an aircraft turbojet engine. This type of composite structure allows to absorb at least partially the acoustic waves generated by the nacelle.

After manufacturing or repairing such composite structure, non-destructive testing is commonly carried out, in order to verify that said part complies with predetermined specifications.

For this, according to the present disclosure, the device 23 for the non-destructive testing of a composite part 21 comprises a first magnetic body 25 and a second magnetic body 27 disposed on either side of the part 21, positioned directly on the walls 29, 31 of the test part 21 to be tested.

According to the present disclosure, the wall 26 of the magnetic body 25 is in contact with the wall 29 of the test part 21, and the wall 28 of the magnetic body 27 is in contact with the wall 31 of the part 21.

As used herein, “magnetic body” should be construed to mean any body adapted to exert a magnetic force or to react to an external magnetic field. In this second case, the magnetic body may be for example a ferromagnetic body which does not generate itself a magnetic field, but which is likely to react to an external magnetic field.

The magnetic bodies 25, 27 of the device according to the present disclosure are in one form made of magnetically hard material such as an alloy of neodymium, iron and boron (NdFeB). In this case, the two magnetic bodies 25, 27 exert an attractive force on each other allowing a mutual holding, or a holding through the one by the other, of the magnetic bodies on either side of the part 21.

Of course, it goes without saying that any other alloy, imparting sufficient magnetic properties to allow the magnetic bodies to attract each other when they are positioned on either side of the test part, may be considered while remaining within the scope of the present disclosure.

The magnetic bodies 25, 27 have preferably a substantially cylindrical shape, which allows to ensures a distribution of the magnetic field essentially along the longitudinal axis of the magnetic body, but here again, a magnetic body having another geometric shape, such as a parallelepiped shape for example, may be quite considered.

The dimensions of the magnetic bodies are further adapted to the test part, that is to say, the magnetic bodies have dimensions shaped such that the magnetic bodies attract each other on either side of the part.

The thickness of the magnetic bodies varies according to the thickness of the test part, the contact surface between the magnetic bodies and the test part remaining advantageously unchanged regardless of the thickness of said part.

The testing device 23 further comprises emitting 33 and receiving 35 ultrasonic probes, the emitting probe 33 being supported by the magnetic body 25 by means of a holding ring 37 secured to the magnetic body 25, and the receiving probe 35 being supported by the magnetic body 27 by means of a holding ring 39 secured to the magnetic body 27.

The holding rings may be fastened to the magnetic bodies by any fastening means known to those skilled in the art, and may also be made of a magnetic material so that the magnetic bodies 25, 27 and/or the holding rings attract each other.

According to an alternative not represented in the figures, the emitting and receiving probes are directly supported by the magnetized bodies, and are positioned directly on the walls opposite to the walls 26 and 28 of the magnetic bodies 25, 27.

The emitting 33 and receiving 35 ultrasonic probes further comprise respectively an emitting ultrasonic transducer and a receiving ultrasonic transducer, not represented in the figures. The used ultrasonic transducers are well known to those skilled in the art and will not be further described in the present description.

Furthermore, the probes 33, 35 are intended to be connected to a data acquiring and processing device (not shown).

According one form of the present disclosure, at least one of the two probes can be driven by an automated control arm which allows the displacement of the two magnetically coupled probes.

The testing method according to the present disclosure is carried out by the following steps:

The two magnetic bodies 25, 27 are directly and respectively positioned on the walls 29, 31 of the test part 21, said bodies being for example positioned substantially facing each other in order to ensure a proper transmission of waves from the emitting probe to the receiving probe. Thus, the magnetic bodies 25, 27 exert an attractive force allowing a mutual holding, or a holding through the one by the other, on either side of the part 21.

The emitting ultrasonic probe 33 is then positioned on the magnetic body 25, whose holding is for example ensured thanks to the holding ring 37, then the receiving ultrasonic probe 35, for example held by means of the holding ring 39, is positioned on the magnetic body 27.

The method for non-destructive testing through transmission ultrasounds according to the present disclosure may further comprise a step for disposing a coupling gel between the ultrasonic probe and the magnetized body which supports it. This advantageously allows a proper propagation of the ultrasonic waves in the test part 21. It may also be considered, alternatively or in addition, to wet the test part, for example by vaporization.

The ultrasonic waves successively propagate from the emitting transducer of the probe 33 to the magnetic body 25, pass through the magnetic body 25, then pass through the test part 21, then pass through the magnetic body 27 before being sensed by the receiving transducer of the receiving probe 35.

The device according to the present disclosure is particularly advantageous when it is desired to test a composite part having a curved profile, such as a sandwich acoustic panel for example.

Indeed, thanks to the present disclosure, by providing to dispose the magnetic bodies directly on the walls of the test part, on either side of the test part, and by providing for an emitting probe and a receiving probe each supported by a magnetic body, only the magnetic bodies are in contact with the walls of the test part, which allows substantially reducing the congestion with respect to the devices known from the prior art.

Furthermore, thanks to the present disclosure, the size of the magnetic bodies is improved, which provides a good congestion/weight/magnetic performance ratio.

Further, the magnetic coupling of the magnetized bodies directly supported by the test part also allows a proper alignment of the ultrasonic probes, and therefore an improved propagation of said waves.

The present disclosure is not limited to the specific forms of the testing device, described above only by way of illustrative examples, but it encompasses, on the contrary, all the variants involving technical equivalents of the described means as well as their combinations if these fall within the scope of the present disclosure.

To this end, the description refers to an acoustic composite part equipping in particular a nacelle for an aircraft turbojet engine. It goes without saying that the testing device and the method claimed below are in no way limited to the testing of this type of part, but concern the testing of any composite part, whether acoustic or not.

What is claimed is:

1. A device for the non-destructive testing of a test composite part comprising:
at least two magnetic bodies, at least one of said at least two magnetic bodies being adapted to exert an attractive force to allow a mutual holding, or a holding through the one by the other, of the magnetic bodies on either side of said test composite part, said magnetic bodies being configured to be positoined directly on at least one wall of the test composite part; and
at least one emitting ultrasonic probe positioned on one of said magnetic bodies, and at least one receiving ultrasonic probe positioned on the other of said magnetic bodies.

2. The device according to claim 1, wherein at least one of said magnetic bodies comprises a holding ring shaped to support at least one of said probes.

3. The device according to claim 1, wherein at least one magnetic body has a substantially cylindrical shape.

4. The device according to claim 1, wherein at least one magnetic body is made of a material selected from the group consisting of neodymium, iron and boron.

5. The device according to claim 1, wherein the at least one emitting ultrasonic probe further comprises at least one emitting ultrasonic transducer and in that the at least one receiving ultrasonic probe further comprises at least one receiving ultrasonic transducer.

6. An assembly comprising:
a test composite part; and
at least one device for the non-destructive testing of said test composite part, said device comprising:
at least two magnetic bodies;
at least one emitting ultrasonic probe; and
at least one receiving ultrasonic probe,
wherein the at least two magnetic bodies are positioned on opposite sides of the test comosite part, directly on a wall of said test composite part, at least one of said at least two magnetic bodies exerting an attractive force adapted to allow a mutual holding, or a holding through the one by the other, of the magnetic bodies on opposite sides of said test composite part, and said at least one emitting and receiving ultrasonic probes are respectively positioned on the one and the other of said at least two magnetic bodies.

7. A method for non-destructive testing of a test composite part through transmission ultrasounds comprising the following steps:
positioning on either side of the test composite part at least two magnetic bodies, so that at least one of said at least two magnetic bodies exerts an attractive force to allow a mutual holding, or a holding through the one by the other, of the magnetic bodies on either side of said test composite part, said magnetic bodies being positioned directly on a wall of the test composite part; and
positioning at least one emitting ultrasonic probe on one of the magnetic bodies and at least one receiving ultrasonic probe on the other of the magnetic bodies.

8. The method according to claim 7 further comprising a step for wetting the test composite part.

9. The method according to claim 9, wherein the test part is wetted by vaporization.

10. The method according to claim 7 wherein said at least two magnetic bodies are positioned substantially facing each other.
